(19) United States
(12) Patent Application Publication
(10) Pub. No.: US 2026/0167758 A1
(43) Pub. Date: Jun. 18, 2026

(54) COMPOSITION OF LATEX FOR DIP MOLDING WITH EXCELLENT CHEMICAL RESISTANCE AND DIP MOLDED ARTICLE PREPARED THEREFROM

(71) Applicant: KOREA KUMHO PETROCHEMICAL CO., LTD., Seoul (KR)

(72) Inventors: Jong Jin JEON, Sejong-si (KR); Sung Hun CHOUNG, Daejeon (KR)

(73) Assignee: KOREA KUMHO PETROCHEMICAL CO., LTD., Seoul (KR)

(21) Appl. No.: 19/371,523

(22) Filed: Oct. 28, 2025

(30) Foreign Application Priority Data
Oct. 29, 2024 (KR) 10-2024-0149594

(51) Int. Cl. C08F 236/12

(52) U.S. Cl. CPC C08F 236/12; C08F 2800/20

(57) ABSTRACT

The present specification provides a latex composition for dip molding comprising a copolymer latex in which an ethylenically unsaturated nitrile monomer, an isoprene monomer, a butadiene monomer, and an ethylenically unsaturated acid monomer are polymerized, wherein the content of the butadiene monomer is 5 to 20 parts by weight based on 100 parts by weight of the total sum of the isoprene monomer and the butadiene monomer, and the gel content of the copolymer latex is 40% to 90%.

### TECHNICAL FIELD

The present specification relates to a latex composition for dip molding with excellent chemical resistance and a dip molded article prepared therefrom.

This application claims priority to and the benefit of Korean Patent Application No. 10-2024-0149594 filed in the Korean Intellectual Property Office on Oct. 29, 2024, and the entire contents of which are incorporated herein by reference.

### BACKGROUND ART

Conventionally, the main raw material for gloves used for medical purposes, agricultural and livestock product processing, or industrial purposes was natural rubber latex. However, when using gloves manufactured from natural rubber latex, a problem frequently occurred in that the user of the gloves suffered from contact allergic diseases due to proteins contained in the natural rubber latex. Accordingly, attempts have been made to manufacture gloves by applying synthetic rubber latex that does not contain proteins, such as nitrile-based copolymer latex. Nitrile-based copolymer latex gloves have superior mechanical strength compared to natural rubber latex gloves, and thus demand is increasing in the medical or food fields where contact with sharp objects frequently occurs.

As the usage of nitrile-based copolymer latex increases, the need for quality improvement of dip molded articles is increasing, and accordingly, attempts are being made to improve the durability, such as tensile strength and elongation, of dip molded articles manufactured from latex for dip molding. However, despite these attempts to improve mechanical properties, cases continue to appear where personal accidents occur or desired objectives are not achieved due to the breakage of dip molded articles.

In particular, molded articles used for the purpose of protecting the human body against chemical reactions and the like need to have chemical resistance to maintain their shape stably without deformation in various solvents, such as the organic solvents acetone, n-hexane, and the like. Technology development is currently required for the manufacture of dip molded articles having excellent durability and chemical resistance, which possess such chemical resistance while maintaining the excellent tensile strength and elongation possessed by existing nitrile-based latex.

### DISCLOSURE

### Technical Problem

The subject matter of the present specification is to solve the problems of the prior art described above, and one object of the present specification is to provide a latex composition for dip molding having excellent chemical resistance and durability due to its high gel content and high degree of crosslinking.

### Technical Solution

According to one aspect, there is provided a latex composition for dip molding comprising a copolymer latex in which an ethylenically unsaturated nitrile monomer, an isoprene monomer, a butadiene monomer, and an ethylenically unsaturated acid monomer are polymerized, wherein the content of the butadiene monomer is 5 to 20 parts by weight based on 100 parts by weight of the total sum of the isoprene monomer and the butadiene monomer, and the gel content of the copolymer latex is 40% to 90%.

In one embodiment, the ethylenically unsaturated nitrile monomer may be one selected from the group consisting of acrylonitrile, methacrylonitrile, fumaronitrile, α-chloronitrile, α-cyanoethylacrylonitrile, and combinations of two or more thereof.

In one embodiment, the ethylenically unsaturated acid monomer may be one selected from the group consisting of acrylic acid, methacrylic acid, itaconic acid, maleic acid, fumaric acid, maleic anhydride, citraconic anhydride, styrenesulfonic acid, monobutyl fumarate, monobutyl maleate, mono-2-hydroxypropyl maleate, and combinations of two or more thereof.

In one embodiment, the copolymer latex may comprise 1 to 55 parts by weight of the ethylenically unsaturated nitrile monomer, 65 to 80 parts by weight of the isoprene monomer, 1 to 10 parts by weight of the butadiene monomer, and 1.5 to 6.0 parts by weight of the ethylenically unsaturated acid monomer.

In one embodiment, the deformation rate represented by the following Formula 1 of a dip molded article manufactured from the latex composition for dip molding may be 50% or less:

$$( Deformation rate ) = ( a - b ) / a * 100. \qquad [ Formula 1 ]$$

(In Formula 1, a means the weight (g) measured after manufacturing a dip molded article having a width of 30 mm, a length of 135 mm, and a thickness of 0.06 to 0.09 mm, and b means the weight measured after immersing the manufactured dip molded article in 80 ml of a solvent and stirring at room temperature for 4 hours).

In one embodiment, the solvent may be one selected from the group consisting of acetone, ethanol, isopropyl alcohol, methyl ethyl ketone, n-heptane, and toluene.

According to another aspect, there is provided a dip molded article manufactured from the latex composition for dip molding.

In one embodiment, the dip molded article may be surgical gloves, medical gloves, gloves for agricultural and livestock product processing, industrial gloves, condoms, cosmetic materials, catheters, or healthcare molded articles.

### Advantageous Effects

The latex composition for dip molding according to one aspect of the present specification has a high gel content and a high degree of crosslinking, thereby having excellent mechanical properties such as elongation, and may have excellent chemical resistance.

Furthermore, the dip molded article according to another aspect of the present specification has excellent chemical resistance and durability, and thus can be applied to various fields such as surgical gloves, medical gloves, gloves for agricultural and livestock product processing, industrial gloves, condoms, cosmetic materials, catheters, and healthcare molded articles.

The effects of one aspect of the present specification are not limited to the effects described above, and should be understood to include all effects that can be inferred from the configuration described in the detailed description or the claims of the present specification.

### MODES OF THE INVENTION

Hereinafter, one aspect of the present specification will be described based on specific examples. However, the subject matter of the present specification may be implemented in various different forms, and thus is not limited to the embodiments described herein.

Throughout the specification, when a part is said to be “connected” to another part, this includes not only the case of being “directly connected” but also the case of being “indirectly connected” with another member interposed therebetween. In addition, when a part is said to “comprise” a certain component, this means that it may further include other components, rather than excluding other components, unless specifically stated to the contrary.

When a range of numerical values is described in the present specification, unless the specific range thereof is otherwise described, the value has the precision of the significant figures provided according to the standard rules in chemistry for significant figures. For example, 10 includes the range of 5.0 to 14.9, and the number 10.0 includes the range of 9.50 to 10.49.

### Latex Composition for Dip Molding

The latex composition for dip molding according to one aspect of the present specification comprises a copolymer latex in which an ethylenically unsaturated nitrile monomer, an isoprene monomer, a butadiene monomer, and an ethylenically unsaturated acid monomer are polymerized.

Among the copolymer latexes in which conventionally used ethylenically unsaturated nitrile monomers, conjugated diene-based monomers, and ethylenically unsaturated acid monomers are polymerized, the most widely known is nitrile-isoprene (NI) copolymer latex. Nitrile-isoprene copolymer latex has characteristics of high elongation and low modulus, resulting in excellent mechanical properties and high durability. However, such nitrile-isoprene copolymer latex somewhat lacks the chemical resistance required for use in latex gloves used in laboratories and the like where chemical reactions are involved, such as experiments. Chemical resistance refers to the property that the shape and physical properties are maintained as they are without dissolving or deforming in various organic solvents and the like. In order to impart chemical resistance to the existing nitrile-isoprene copolymer latex, the present inventors, after repeated experiments, confirmed that if butadiene is utilized together with isoprene as conjugated diene-based monomers, a latex for dip molding having a high gel content, excellent durability, and secured chemical resistance can be obtained, thereby completing the present invention.

In the latex composition for dip molding of the present invention, the content of the butadiene monomer is 5 to 20 parts by weight based on 100 parts by weight of the total sum of the isoprene monomer and the butadiene monomer, and preferably may be 7 to 19.5 parts by weight, more preferably 8 to 19 parts by weight, even more preferably 10 to 18.5 parts by weight, and most preferably more than 10 parts by weight and less than 18.5 parts by weight, but is not limited thereto. For example, the content of the butadiene monomer based on 100 parts by weight of the total sum of the isoprene monomer and the butadiene monomer may be 5 parts by weight, 5.5 parts by weight, 6 parts by weight, 6.5 parts by weight, 7 parts by weight, 7.5 parts by weight, 8 parts by weight, 8.5 parts by weight, 9 parts by weight, 9.5 parts by weight, 10 parts by weight, 10.5 parts by weight, 11 parts by weight, 11.5 parts by weight, 12 parts by weight, 12.5 parts by weight, 13 parts by weight, 13.5 parts by weight, 14 parts by weight, 14.5 parts by weight, 15 parts by weight, 15.5 parts by weight, 16 parts by weight, 16.5 parts by weight, 17 parts by weight, 17.5 parts by weight, 18 parts by weight, 18.5 parts by weight, 19 parts by weight, 19.5 parts by weight, 20 parts by weight, or a value between any two of these values. If the content of the butadiene monomer satisfies the above range based on 100 parts by weight of the total sum of the isoprene monomer and the butadiene monomer, the gel content of the manufactured copolymer latex is formed high, so that the degree of crosslinking may appear high, and accordingly, the chemical resistance of the manufactured dip molded article to solvents may appear excellent.

In the latex composition for dip molding of the present invention, the gel content of the copolymer latex is 40% to 90%, and preferably may be 40% to 80%, more preferably 48% to 75%, and most preferably 50% to 70%, but is not limited thereto. For example, the gel content of the copolymer latex may be 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, or a value between any two of these values. In the copolymer latex, a higher gel content means more crosslinks. If the gel content of the copolymer latex exceeds the above range, the mechanical properties of the manufactured latex for dip molding may be deteriorated due to excessive agglomeration, and if it is less than the above range, it may be easily deformed by shear force during dip molding, so that the mechanical properties of the manufactured latex for dip molding may be deteriorated, and furthermore, the degree of crosslinking may appear low, and accordingly, the chemical resistance of the manufactured dip molded article to solvents may become poor.

The ethylenically unsaturated nitrile monomer may be one selected from the group consisting of acrylonitrile, methacrylonitrile, fumaronitrile, α-chloronitrile, α-cyanoethylacrylonitrile, and combinations of two or more thereof, but is not limited thereto. In the copolymer of the latex for dip molding, the structure derived from the ethylenically unsaturated nitrile monomer can improve the strength and chemical resistance of the dip molded article.

The ethylenically unsaturated acid monomer may be one selected from the group consisting of acrylic acid, methacrylic acid, itaconic acid, maleic acid, fumaric acid, maleic anhydride, citraconic anhydride, styrenesulfonic acid, monobutyl fumarate, monobutyl maleate, mono-2-hydroxypropyl maleate, and combinations of two or more thereof, but is not limited thereto. In the copolymer of the latex for dip molding, the structure derived from the ethylenically unsaturated acid monomer can form a crosslinked structure to improve the mechanical properties of the dip molded article.

The copolymer latex may comprise 1 to 55 parts by weight of the ethylenically unsaturated nitrile monomer, 65 to 80 parts by weight of the isoprene monomer, 1 to 10 parts by weight of the butadiene monomer, and 1.5 to 6.0 parts by weight of the ethylenically unsaturated acid monomer, but is not limited thereto.

For example, the content of the ethylenically unsaturated nitrile monomer in the copolymer latex may be 1 part by weight, 2.5 parts by weight, 5 parts by weight, 7.5 parts by weight, 10 parts by weight, 12.5 parts by weight, 15 parts by weight, 17.5 parts by weight, 20 parts by weight, 22.5 parts by weight, 25 parts by weight, 27.5 parts by weight, 30 parts by weight, 32.5 parts by weight, 35 parts by weight, 37.5 parts by weight, 40 parts by weight, 42.5 parts by weight, 45 parts by weight, 47.5 parts by weight, 50 parts by weight, 52.5 parts by weight, 55 parts by weight, ¹or a value between any two of these values. If the content of the ethylenically unsaturated nitrile monomer is less than the above range, the chemical resistance or mechanical strength of the dip molded article may be deteriorated, and if it exceeds the above range, the elongation of the dip molded article may be deteriorated, leading to deteriorated usability.

For example, the content of the isoprene monomer in the copolymer latex may be 65 parts by weight, 66 parts by weight, 67 parts by weight, 68 parts by weight, 69 parts by weight, 70 parts by weight, 71 parts by weight, 72 parts by weight, 73 parts by weight, 74 parts by weight, 75 parts by weight², 76 parts by weight, 77 parts by weight, 78 parts by weight, 79 parts by weight, 80 parts by weight, or a value between any two of these values. If the content of the isoprene monomer is less than the above range, the dip molded article may be excessively cured, resulting in poor wearing sensation, and if it exceeds the above range, the durability and chemical resistance of the dip molded article may be deteriorated.

For example, the content of the butadiene monomer in the copolymer latex may be 1 part by weight, 1.5 parts by weight, 2 parts by weight, 2.5 parts by weight, 3 parts by weight, 3.5 parts by weight, 4 parts by weight, 4.5 parts by weight, 5 parts by weight, 5.5 parts by weight, 6 parts by weight, 6.5 parts by weight, 7 parts by weight, 7.5 parts by weight, 8 parts by weight, 8.5 parts by weight, 9 parts by weight, 9.5 parts by weight, 10 parts by weigh³t, or a value between any two of these values. If the content of the butadiene monomer is less than the above range, the degree of crosslinking of the latex is lowered, leading to a lower gel content, which may deteriorate the chemical resistance, and if it exceeds the above range, the durability and chemical resistance of the dip molded article may be deteriorated.

For example, the content of the ethylenically unsaturated acid monomer in the copolymer latex may be 1.5 parts by weight, 2 parts by weight, 2.5 parts by weight, 3 parts by weight, 3.5 parts by weight, 4 parts by weight, 4.5 parts by weight, 5 parts by weight, 5.5 parts by weight, 6 parts by weight, or a value between any two of these values. If the content of the ethylenically unsaturated acid monomer is less than the above range, the tensile strength of the dip molded article may be deteriorated, and if it exceeds the above range, the dip molded article may be excessively cured, resulting in poor wearing sensation.

The weight ratio of the butadiene monomer to the isoprene monomer may be 0.15 to 0.7, and most preferably 0.2 to 0.65, but is not limited thereto. If the weight ratio of the butadiene monomer to the isoprene monomer is outside the above range, the durability and chemical resistance of the dip molded article manufactured from the composition may be deteriorated.

The weight ratio of the isoprene to the ethylenically unsaturated nitrile monomer may be 2.1 to 3.5. If the weight ratio of the isoprene to the ethylenically unsaturated nitrile monomer is outside the above range, the durability and chemical resistance of the dip molded article manufactured from the composition may be deteriorated.

The weight ratio of the ethylenically unsaturated acid monomer to the ethylenically unsaturated nitrile monomer may be 0.1 to 0.4. If the weight ratio of the ethylenically unsaturated acid monomer to the ethylenically unsaturated nitrile monomer is outside the above range, the durability and chemical resistance of the dip molded article manufactured from the composition may be deteriorated.

In the present specification, “total sum of monomers” means the sum of the isoprene monomer, the butadiene monomer, the ethylenically unsaturated nitrile monomer, and the ethylenically unsaturated acid monomer, but the latex composition for dip molding may further comprise polymerizable monomers other than the aforementioned isoprene monomer, butadiene monomer, ethylenically unsaturated nitrile monomer, and ethylenically unsaturated acid monomer, and in this case, “total sum of monomers” further includes the polymerizable monomers.

The composition may further comprise water, an emulsifier, a polymerization initiator, and a molecular weight modifier.

The content of the water may be 75 to 150 parts by weight based on 100 parts by weight of the total sum of monomers, for example, 75 parts by weight, 77.5 parts by weight, 80 parts by weight, 82.5 parts by weight, 85 parts by weight, 87.5 parts by weight, 90 parts by weight, 92.5 parts by weight, 95 parts by weight, 97.5 parts by weight, 100 parts by weight, 102.5 parts by weight, 105 parts by weight, 107.5 parts by weight, 110 parts by weight, 112.5 parts by weight, 115 parts by weight, 117.5 parts by weight, 120 parts by weight, 122.5 parts by weight, 125 parts by weight, 127.5 parts by weight, 130 parts by weight, 132.5 parts by weight, 135 parts by weight, 137.5 parts by weight, 140 parts by weight, 142.5 parts by weight, 145 parts by weight, 147.5 parts by weight, 150 parts by weight, or a value between any two of these values. If the content of the water is less than the above range, the viscosity during polymerization may excessively increase, making it difficult to manufacture the molded article, and if it exceeds the above range, the solid content may become excessively low. The water may have an ion conductivity of 5 μS/cm or less, 2.5 μS/cm or less, or 1 μS/cm or less. For example, the water may be ion-exchanged water, ultrapure water, or purified water. If water with high ion conductivity is used, impurities that adversely affect polymerization stability or latex stability may be included.

The emulsifier may be an anionic surfactant, a nonionic surfactant, a cationic surfactant, or an amphoteric surfactant. For example, as the anionic surfactant, one or more selected from the group consisting of alkylbenzene sulfonates, aliphatic sulfonates, higher alcohol sulfate ester salts, α-olefin sulfonates, and alkyl ether sulfate ester salts may be used, but it is not limited thereto. The emulsifier may be added in an amount of 0.8 to 8 parts by weight based on 100 parts by weight of the total sum of monomers.

The polymerization initiator may be a radical initiator. The radical initiator may be, for example, one or more of: inorganic peroxides selected from the group consisting of sodium persulfate, potassium persulfate, ammonium persulfate, potassium perphosphate, and hydrogen peroxide; organic peroxides selected from the group consisting of t-butyl peroxide, cumene hydroperoxide, p-menthane hydroperoxide, di-t-butyl peroxide, t-butylcumyl peroxide, acetyl peroxide, isobutyl peroxide, octanoyl peroxide, dibenzoyl peroxide, 3,5,5-trimethylhexanol peroxide, and t-butyl peroxyisobutyrate; azo-based initiators selected from the group consisting of azobisisobutyronitrile, azobis-2,4-dimethylvaleronitrile, azobiscyclohexanecarbonitrile, and methyl azobisisobutyrate (butyl acid), but is not limited thereto. The polymerization initiator may be added in an amount of 0.01 to 1.5 parts by weight based on 100 parts by weight of the total sum of monomers.

The molecular weight modifier may be mercaptans such as α-methylstyrene dimer, t-dodecyl mercaptan, n-dodecyl mercaptan, and octyl mercaptan; halogenated hydrocarbons such as carbon tetrachloride, methylene chloride, and methylene bromide; sulfur-containing compounds such as tetraethylthiuram disulfide, dipentamethylenethiuram disulfide, and diisopropylxanthogen disulfide, but is not limited thereto. The content of the molecular weight modifier may be 0.1 to 1 part by weight based on 100 parts by weight of the total sum of monomers. For example, it may be 0.1 part by weight, 0.15 part by weight, 0.2 part by weight, 0.25 part by weight, 0.3 part by weight, 0.35 part by weight, 0.4 part by weight, 0.45 part by weight, 0.5 part by weight, 0.55 part by weight, 0.6 part by weight, 0.65 part by weight, 0.7 part by weight, 0.75 part by weight, 0.8 part by weight, 0.85 part by weight, 0.9 part by weight, 0.95 part by weight, 1 part by weight, or a value between any two of these values. If the content of the molecular weight modifier is less than the above range, latex stability may be deteriorated, and if it exceeds the above range, mechanical properties may be deteriorated or chemical resistance may be deteriorated.

The average particle diameter of the copolymer latex may be 1,000 to 3,000 Å. For example, it may be 1,000 Å, 1,050 Å, 1,100 Å, 1,150 Å, 1,200 Å, 1,250 Å, 1,300 Å, 1,350, 1,400 Å, 1,450 Å, 1,500 Å, 1,550 Å, 1,600 Å, 1,650 Å, 1,700, 1,750 Å, 1,800 Å, 1,850 Å, 1,900 Å, 1,950 Å, 2,000 Å, 2,050 Å, 2,100 Å, 2,150 Å, 2,200 Å, 2,250 Å, 2,300 Å, 2,350 Å, 2,400 Å, 2,450 Å, 2,500 Å, 2,550 Å, 2,600 Å, 2,650 Å, 2,700 Å, 2,750 Å, 2,800 Å, 2,850 Å, 2,900 Å, 2,950 Å, 3,000 Å, or a range between any two of these values. The copolymer latex is manufactured by copolymerizing two types of conjugated diene-based monomers, whereby stability is secured and the gel content is maintained high, resulting in excellent chemical resistance to solvents.

The viscosity of the copolymer latex at 25° C. may be 50 to 2,500 cps, for example, 50 cps, 75 cps, 100 cps, 125 cps, 150 cps, 175 cps, 200 cps, 225 cps, 250 cps, 275 cps, 300 cps, 325 cps, 350 cps, 375 cps, 400 cps, 425 cps, 450 cps, 475 cps, 500 cps, 525 cps, 550 cps, 575 cps, 600 cps, 625 cps, 650 cps, 675 cps, 700 cps, 725 cps, 750 cps, 775 cps, 800 cps, 825 cps, 850 cps, 875 cps, 900 cps, 925 cps, 950 cps, 975 cps, 1,000 cps, 1,100 cps, 1,200 cps, 1,300 cps, 1,400 cps, 1,500 cps, 1,600 cps, 1,700 cps, 1,800 cps, 1,900 cps, 2,000 cps, 2,100 cps, 2,200 cps, 2,300 cps, 2,400 cps, 2,500 cps, or a range between any two of these values. If the viscosity of the copolymer latex is outside the above range, manufacturing may be practically impossible, or dip molding may be difficult.

The solid content of the copolymer latex may be 45 to 65 wt %, for example, 45 wt %, 47.5 wt %, 50 wt %, 52.5 wt %, 55 wt %, 57.5 wt %, 60 wt %, 62.5 wt %, 65 wt %, or a range between any two of these values. If the solid content of the copolymer latex is outside the above range, the effect due to the aforementioned stability improvement may be unnecessary, or agglomeration of the latex may occur.

The characteristics of the copolymer latex may be measured at pH 8.0 to 10.0, for example, pH 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0. When the pH of the latex is adjusted through additives, the solid content and the average particle diameter may change, but the copolymer latex can simultaneously satisfy the aforementioned average particle diameter, solid content, and viscosity requirements within the above pH range.

The latex composition for dip molding may further comprise one or more additives selected from the group consisting of chelating agents, dispersants, pH adjusters, deoxidizers, particle size adjusters, anti-aging agents, and oxygen scavengers. As these additives, known configurations in the art can be used, and they may be added before or after the polymerization of the copolymer.

### Method for Manufacturing Latex for Dip Molding

The method for manufacturing latex for dip molding according to another aspect of the present specification may comprise (a) preparing a monomer mixture comprising an isoprene monomer, a butadiene monomer, an ethylenically unsaturated nitrile monomer, and an ethylenically unsaturated acid monomer; (b) adding an emulsifier and water to the monomer mixture; and (c) adding a polymerization initiator to manufacture the latex for dip molding.

Step (a) is a step of preparing a monomer mixture comprising the isoprene monomer, the butadiene monomer, the ethylenically unsaturated nitrile monomer, and the ethylenically unsaturated acid monomer, which are monomers constituting the carboxylic acid-modified nitrile-based copolymer, and may be performed under a nitrogen atmosphere.

Steps (b) and (c) are steps of manufacturing the aforementioned copolymer latex by adding additives and water. In step (b), a molecular weight modifier may be further added.

The polymerization of step (c) may be performed at 10 to 90° C., for example, 10° C., 15° C., 20° C., 25° C., 30° C., 35° C., 40° C., 45° C., 50° C., 55° C. 60° C., 65° C., 70° C., 75° C., 80° C., 85° C., 90° C., or a temperature between any two of these temperatures, but is not limited thereto, and the polymerization temperature can be adjusted according to the target conversion rate.

The polymerization of step (c) may be performed for 2 to 24 hours, for example, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, or a time between any two of these times, but is not limited thereto.

Step (c) may further comprise a step of stopping the polymerization by adding a polymerization terminator.

The polymerization terminator may be one selected from the group consisting of sodium hydroxide, hydroxylamine, hydroxylamine sulfate, diethylhydroxylamine, hydroxylamine sulfonic acid and its alkali metal ions, sodium dimethyldithiocarbamate, hydroquinone derivatives, aromatic hydroxydithiocarboxylic acids such as hydroxydiethylbenzene dithiocarboxylic acid and hydroxydibutylbenzene dithiocarboxylic acid, and combinations of two or more thereof. The content of the polymerization terminator may be 0.02 to 1.5 parts by weight based on 100 parts by weight of the monomer mixture.

In step (c), the final conversion rate of the polymerization reaction may be 92% or more. For example, it may be 92% or more, 93% or more, 94% or more, 95% or more, 96% or more, 97% or more, 98% or more, but is not limited thereto. If the conversion rate is less than the above range, the amount of residual unreacted monomers increases, which may deteriorate the mechanical properties and practical use durability of the dip molded article manufactured therefrom.

Other matters regarding the raw materials, contents, etc. used in the manufacturing method are as described above.

### Dip Molded Article

The dip molded article according to yet another aspect of the present specification may be manufactured from the aforementioned latex composition for dip molding.

The dip molded article may be manufactured by adding 1 to 2 parts by weight of sulfur, 1.5 to 4 parts by weight of a crosslinking agent, and 0.3 to 1.5 parts by weight of a vulcanization accelerator to the aforementioned latex for dip molding based on 100 parts by weight of the latex for dip molding, and then performing dip molding, but is not limited thereto.

The sulfur can react with the structure derived from the conjugated diene-based monomer to form a crosslinked structure. When the isoprene monomer and the butadiene monomer are added within the above weight ratio range, shrinkage of the molded article due to syneresis during vulcanization can be suppressed. The content of the sulfur may be, for example, 1 part by weight, 1.1 parts by weight, 1.2 parts by weight, 1.3 parts by weight, 1.4 parts by weight, 1.5 parts by weight, 1.6 parts by weight, 1.7 parts by weight, 1.8 parts by weight, 1.9 parts by weight, 2 parts by weight, or a value between any two of these values. If the content of sulfur is less than the above range, mechanical properties such as tensile strength and chemical resistance may be deteriorated, and if it exceeds the above range, it may cause allergic reactions in the user.

The crosslinking agent can form an ionic bond with the structure derived from the ethylenically unsaturated acid to form a crosslinked structure. The crosslinking agent may be one or more selected from the group consisting of zinc oxide or titanium oxide. For example, the content of the crosslinking agent may be 1.5 parts by weight, 1.6 parts by weight, 1.7 parts by weight, 1.8 parts by weight, 1.9 parts by weight, 2.0 parts by weight, 2.1 parts by weight, 2.2 parts by weight, 2.3 parts by weight, 2.4 parts by weight, 2.5 parts by weight, 2.6 parts by weight, 2.7 parts by weight, 2.8 parts by weight, 2.9 parts by weight, 3.0 parts by weight, 3.1 parts by weight, 3.2 parts by weight, 3.3 parts by weight, 3.4 parts by weight, 3.5 parts by weight, 3.6 parts by weight, 3.7 parts by weight, 3.8 parts by weight, 3.9 parts by weight, 4.0 parts by weight, ⁴or a value between any two of these values. If the content of the crosslinking agent is less than the above range, durability and chemical resistance may be deteriorated, and if it exceeds the above range, tensile strength may be deteriorated.

The dip molded article may be obtained by adjusting the solid content by adding an aqueous potassium hydroxide solution to the latex for dip molding, and then performing dip molding, but is not limited thereto.

The tensile strength of the dip molded article may be 3 MPa or more, 5 MPa or more, 7 MPa or more, 9 MPa or more, 11 MPa or more, 13 MPa or more, 15 MPa or more, 20 MPa or more, 25 MPa or more, 30 MPa or more, or 35 MPa or more, but is not limited thereto. The higher the tensile strength, the better the durability during storage, but other mechanical properties such as elongation may decrease.

The elongation of the dip molded article may be 600% or more, 650% or more, 700% or more, 750% or more, 800% or more, 850% or more, or 900% or more, but is not limited thereto. The higher the elongation, the better the wearing sensation and the like, but it may be in a trade-off relationship with other mechanical properties.

The deformation rate test result of the dip molded article according to the following chemical resistance test method is 50% or less, indicating high quality with excellent durability without dissolving in various organic solvents or structural deformation. For example, the deformation rate test result of the dip molded article may be 50% or less, 40% or less, 30% or less, 20% or less, 10% or less, 5% or less.

### [Chemical Resistance Test Method]

When the weight measured first after manufacturing a dip molded article having a width of 30 mm, a length of 135 mm, and a thickness of 0.06 to 0.09 mm is defined as a(g), and the weight measured after immersing the manufactured dip molded article in 80 ml of a solvent and stirring at room temperature for 4 hours is defined as b(g), the deformation rate calculated through the following Formula 1 may be 50% or less as described above.

$$( Deformation rate ) = ( a - b ) / a * 100. \qquad [ Formula 1 ]$$

The chemical resistance test method confirms the weight change of the specimen when immersed for a long time in an organic solvent with high contact possibility during actual use of the dip molded article, thereby confirming whether it is deformed or the weight increases due to the solvent, and can measure the chemical resistance of the dip molded article under the actual use conditions of the molded article.

The solvent used in the chemical resistance test may be one selected from the group consisting of acetone, ethanol, isopropyl alcohol, methyl ethyl ketone, n-heptane, and toluene. In particular, the dip molded article manufactured from the latex composition for dip molding of the present invention exhibits a low deformation rate by organic solvents having hydrophilic groups such as ethanol and isopropyl alcohol, so that the swelling phenomenon does not occur, and the physical properties are not deteriorated even by long-term work, thereby increasing the work convenience of the worker.

When the solvent used in the chemical resistance test is acetone, the deformation rate calculated through Formula 1 may be 50% or less, preferably 40% or less, more preferably 30% or less, and even more preferably 25% or less, but is not limited thereto.

The dip molded article may be surgical gloves, medical gloves, gloves for agricultural and livestock product processing, industrial gloves, condoms, cosmetic materials, catheters, or healthcare molded articles, but is not limited thereto. For example, the dip molded article may be surgical gloves or other medical gloves, industrial gloves such as chemical handling gloves, or cosmetic materials such as puffs.

Hereinafter, the embodiments of the present specification will be described in more detail. However, the following experimental results describe only representative experimental results among the embodiments, and the scope and content of the present specification cannot be construed as being reduced or limited by the embodiments and the like. The respective effects of various embodiments of the present specification not explicitly presented below will be specifically described in the corresponding parts.

### EXAMPLES AND COMPARATIVE EXAMPLES

A 5 L high-pressure reactor equipped with a stirrer, a thermometer, a condenser, and a nitrogen gas inlet, and configured to allow continuous introduction of each component such as monomers, emulsifier, and polymerization initiator, was prepared. As ion-exchanged water, one having a conductivity of 1 μS/cm or less was prepared. After purging the reactor with nitrogen, a monomer mixture prepared by mixing Isoprene (IP), 1,3-butadiene (BD), Acrylonitrile (AN), and Methacrylic acid (MAA) according to the weights listed in Table 1 below based on the total weight of the monomer mixture was introduced. Thereafter, based on 100 parts by weight of the monomer mixture, 0.5 parts by weight of t-dodecyl mercaptan (TDDM) as a molecular weight modifier, 2 parts by weight of sodium alkylbenzene sulfonate as an emulsifier, and 120 parts by weight of ion-exchanged water were introduced into the reactor to prepare a latex composition for dip molding. After raising the temperature of the reactor to 40° C., 0.3 parts by weight of sodium persulfate as a polymerization initiator was introduced. When the conversion rate reached about 98% after polymerization for 12 hours, 0.9 parts by weight of sodium hydroxide was introduced to stop the polymerization reaction. Thereafter, unreacted monomers and the like were removed through a deodorization process, and ammonia water, antioxidant, antifoaming agent, and the like were added to obtain a copolymer latex having a solid concentration of 45 to 55% and a pH of 8.6 to 9.0.

TABLE 1

| Classification | | | | | Butadiene / |
|---|---|---|---|---|---|
| (Parts by | Iso- | 1,3- | Acrylo- | Methacrylic | (Isoprene + |
| weight) | prene | butadiene | nitrile | acid | Butadiene) |
| Example 1 | 67 | 8 | 20 | 5 | 10.7 |
| Example 2 | 65.1 | 9.9 | 20 | 5 | 13.2 |
| Example 3 | 64.8 | 7.2 | 23 | 5 | 10.0 |
| Example 4 | 60.5 | 6.5 | 27 | 6 | 9.7 |
| Example 5 | 63.8 | 3.2 | 25 | 6 | 10.9 |
| Example 6 | 56.8 | 11.2 | 26 | 6 | 16.5 |
| Example 7 | 60.5 | 13.5 | 21 | 5 | 18.2 |
| Example 8 | 60.5 | 12.5 | 21 | 6 | 17.1 |
| Comparative | 72 | 0 | 23 | 5 | 0 |
| Example 1 | | | | | |
| Comparative | 69.5 | 2.5 | 23 | 5 | 3.5 |
| Example 2 | | | | | |
| Comparative | 63.8 | 3.2 | 27 | 6 | 4.8 |
| Example 3 | | | | | |
| Comparative | 66 | 3 | 27 | 4 | 4.3 |
| Example 4 | | | | | |

### Experimental Example 1: Evaluation of Gel Content

The gel content of the copolymer latex obtained in the Examples and Comparative Examples was measured by the following method and recorded in Table 2.

5 g of each copolymer latex prepared according to Examples 1 to 8 and Comparative Examples 1 to 4 was added to 200 mL of stirring isopropyl alcohol to coagulate it. The coagulum was filtered through a 120 mesh wire mesh, dried in a constant temperature vacuum dryer at 50±2° C. and 750±10 mmHg for 1 hour, and then left to stand at room temperature in a desiccator. 0.25 to 0.35 g of the dried sample was accurately weighed (Wi) with a precision of 0.1 mg unit, placed in a triangular flask, and 100 mL of methyl ethyl ketone (MEK) was added, followed by stirring for 2 hours. Thereafter, the entire amount of the sample was filtered through a filter paper. 20 mL of the filtrate was heated to evaporate the methyl ethyl ketone, cooled to room temperature in a desiccator, and then accurately weighed (Wf) with a precision of 0.1 mg unit. The gel content in the sample was measured according to the following Formula 2, and the average value of two measurements was calculated up to the first decimal place.

$$Gel content ( \% ) = 100 - ( Wf \times 5 / Wi ) \times 100 \qquad [ Formula 2 ]$$

TABLE 2

| | Exam- | Exam- | Exam- | Exam- | Exam- | Exam- | Exam- | Exam- | Comp. | Comp. | Comp. | Comp. |
|---|---|---|---|---|---|---|---|---|---|---|---|---|
| Classification | ple 1 | ple 2 | ple 3 | ple 4 | ple 5 | ple 6 | ple 7 | ple 8 | Ex. 1 | Ex. 2 | Ex. 3 | Ex. 4 |
| Gel content (%) | 50.1 | 59 | 47.3 | 46.8 | 50.2 | 60 | 61.9 | 58.3 | 0 | 10.9 | 12.5 | 15.2 |

Referring to Table 2, it can be seen that Examples 1 to 8 all showed a gel content of 40% or more, indicating that crosslinks were excellently formed. In Comparative Example 1, which did not contain the butadiene monomer, the gel content was 0%, indicating that crosslinks were not formed at all. In Comparative Examples 2 to 4, where the butadiene monomer did not exceed 5 parts by weight based on 100 parts by weight of the total conjugated diene-based monomers, the gel content was low at 20% or less, indicating that crosslinks were insufficiently formed.

### Preparation Example

To 100 parts by weight of each copolymer latex prepared according to the Examples and Comparative Examples, 1.0 part by weight of sulfur (S), 0.7 parts by weight of zinc oxide (ZnO), 1.0 part by weight of titanium oxide (TiO2), and 1.0 part by weight of zinc dibutyldithiocarbamate (ZDBC) as a vulcanization accelerator were added. Thereafter, the temperature was raised to 120-150° C. to proceed with the vulcanization reaction, secondary distilled water was added to remove residues at 50° C. for 2 minutes, and then a latex composition for dip molding having a solid concentration of 45% and pH 8.5 was prepared.

### Experimental Example 2: Evaluation of Chemical Resistance

Rectangular specimens having a width of 30 mm, a length of 135 mm, and a thickness of 0.080 to 0.089 mm were prepared from each latex composition for dip molding prepared according to the Preparation Example, and the chemical resistance of the specimens was evaluated. The results are shown in Tables 3 to 5 below. Table 3 shows the experimental results using acetone as a solvent, Table 4 shows the experimental results using ethanol as a solvent, and Table 5 shows the experimental results using methyl ethyl ketone as a solvent.

The initial weight of the manufactured dip molded article was measured and recorded (a(g)). The manufactured dip molded article was immersed in 80 ml of solvent and stirred at room temperature for 4 hours. Then, the swollen molded article was taken out with tweezers, the solvent on the surface was physically removed, and the weight was measured and recorded (b(g)). Thereafter, the deformation rate was calculated by the aforementioned Formula 1 and shown in Tables 3 to 5.

TABLE 3

| | | | Deformation rate = (a − |
|---|---|---|---|
| Acetone immersion | a | b | b)/a * 100 |
| Example 1 | 0.5120 | 0.3900 | 23.83 |
| Example 2 | 0.5321 | 0.4210 | 20.88 |
| Example 3 | 0.6125 | 0.3690 | 39.76 |
| Example 4 | 0.6342 | 0.3956 | 37.62 |
| Example 5 | 0.6321 | 0.5551 | 12.18 |
| Example 6 | 0.4963 | 0.4025 | 18.90 |
| Example 7 | 0.4896 | 0.3980 | 18.71 |
| Example 8 | 0.5123 | 0.4235 | 17.33 |
| Comparative Example 1 | 0.4985 | 0.0860 | 82.75 |
| Comparative Example 2 | 0.4867 | 0.1020 | 79.04 |
| Comparative Example 3 | 0.5130 | 0.1123 | 78.11 |
| Comparative Example 4 | 0.4986 | 0.1568 | 68.55 |

TABLE 4

| | | | Deformation rate = (a − |
|---|---|---|---|
| Ethanol immersion | a | b | b)/a * 100 |
| Example 1 | 0.5350 | 0.3890 | 27.29 |
| Example 2 | 0.4968 | 0.3895 | 21.60 |
| Example 3 | 0.6326 | 0.4039 | 36.15 |
| Example 4 | 0.5896 | 0.3980 | 32.50 |
| Example 5 | 0.6125 | 0.3956 | 35.41 |
| Example 6 | 0.5986 | 0.4989 | 16.66 |
| Example 7 | 0.6265 | 0.4896 | 21.85 |
| Example 8 | 0.5665 | 0.4223 | 25.45 |
| Comparative Example 1 | 0.4856 | 0.2103 | 56.69 |
| Comparative Example 2 | 0.5123 | 0.2598 | 49.29 |
| Comparative Example 3 | 0.5136 | 0.2120 | 58.72 |
| Comparative Example 4 | 0.5623 | 0.2694 | 52.09 |

TABLE 5

| Methyl ethyl ketone | | | Deformation rate = (a − |
|---|---|---|---|
| immersion | a | b | b)/a * 100 |
| Example 1 | 0.6891 | 0.5023 | 27.11 |
| Example 2 | 0.5954 | 0.3865 | 35.09 |
| Example 3 | 0.4896 | 0.3022 | 38.28 |
| Example 4 | 0.5986 | 0.3720 | 37.85 |
| Example 5 | 0.5894 | 0.4756 | 19.31 |
| Example 6 | 0.5989 | 0.4231 | 29.35 |
| Example 7 | 0.5056 | 0.3598 | 28.84 |
| Example 8 | 0.4896 | 0.3256 | 33.50 |
| Comparative Example 1 | 0.5345 | 0.2984 | 44.17 |
| Comparative Example 2 | 0.5216 | 0.3029 | 41.93 |
| Comparative Example 3 | 0.6102 | 0.1956 | 67.94 |
| Comparative Example 4 | 0.4445 | 0.2559 | 42.43 |

Referring to Tables 3 to 5, the specimens prepared using the latexes of Examples 1 to 8 showed excellent chemical resistance compared to the specimens prepared using the latexes of Comparative Examples 1 to 4. In the present invention, it was confirmed that by controlling the content of the butadiene monomer to 5 to 20 parts by weight based on 100 parts by weight of the total sum of the isoprene monomer and the butadiene monomer, the degree of crosslinking was formed high, resulting in a high gel content, and accordingly a low deformation rate was recorded. In particular, it was confirmed that they exhibited very superior chemical resistance compared to the Comparative Examples against ketones and ethanol utilized in various chemical reactions, such as acetone and ethanol. On the other hand, the specimen prepared using the latex of Comparative Example 3 recorded a deformation rate of 50% or more for all solvents, indicating that the chemical resistance in organic solvents was insufficient.

The description of the present specification described above is for illustrative purposes, and those skilled in the art to which one aspect of the present specification pertains will understand that it can be easily modified into other specific forms without changing the technical spirit or essential features described in the present specification. Therefore, the embodiments described above should be understood as illustrative in all aspects and not restrictive. For example, each component described as a single type may be implemented in a distributed manner, and likewise, components described as distributed may also be implemented in a combined form.

The scope of the present specification is indicated by the claims described below, and all changes or modified forms derived from the meaning and scope of the claims and their equivalent concepts should be interpreted as being included in the scope of the present specification.

1. A latex composition for dip molding comprising a copolymer latex in which an ethylenically unsaturated nitrile monomer, an isoprene monomer, a butadiene monomer, and an ethylenically unsaturated acid monomer are polymerized,
wherein the content of the butadiene monomer is 5 to 20 parts by weight based on 100 parts by weight of the total sum of the isoprene monomer and the butadiene monomer, and the gel content of the copolymer latex is 40% to 90%.

2. The latex composition for dip molding according to claim 1,
wherein the ethylenically unsaturated nitrile monomer is one selected from the group consisting of acrylonitrile, methacrylonitrile, fumaronitrile, α-chloronitrile, α-cyanoethylacrylonitrile, and combinations of two or more thereof.

3. The latex composition for dip molding according to claim 1,
wherein the ethylenically unsaturated acid monomer is one selected from the group consisting of acrylic acid, methacrylic acid, itaconic acid, maleic acid, fumaric acid, maleic anhydride, citraconic anhydride, styrenesulfonic acid, monobutyl fumarate, monobutyl maleate, mono-2-hydroxypropyl maleate, and combinations of two or more thereof.

4. The latex composition for dip molding according to claim 1,
wherein the copolymer latex comprises 1 to 55 parts by weight of the ethylenically unsaturated nitrile monomer, 65 to 80 parts by weight of the isoprene monomer, 1 to 10 parts by weight of the butadiene monomer, and 1.5 to 6.0 parts by weight of the ethylenically unsaturated acid monomer.

5. The latex composition for dip molding according to claim 1,
wherein the deformation rate represented by the following Formula 1 of a dip molded article manufactured from the latex composition for dip molding is 50% or less:
(Deformation rate)=(a−b)/a*100 [Formula 1]
(In Formula 1, a means the weight (g) measured after manufacturing a dip molded article having a width of 30 mm, a length of 135 mm, and a thickness of 0.06 to 0.09 mm, and b means the weight (g) measured after immersing the manufactured dip molded article in 80 ml of a solvent and stirring at room temperature for 4 hours).

6. The latex composition for dip molding according to claim 5,
wherein the solvent is one selected from the group consisting of acetone, ethanol, isopropyl alcohol, methyl ethyl ketone, n-heptane, and toluene.

7. A dip molded article manufactured from the latex composition for dip molding according to claim 1.

8. The dip molded article according to claim 7,
wherein the dip molded article is surgical gloves, medical gloves, gloves for agricultural and livestock product processing, industrial gloves, condoms, cosmetic materials, catheters, or healthcare molded articles.

9. A dip molded article manufactured from the latex composition for dip molding according to claim 2.

10. The dip molded article according to claim 9,
wherein the dip molded article is surgical gloves, medical gloves, gloves for agricultural and livestock product processing, industrial gloves, condoms, cosmetic materials, catheters, or healthcare molded articles.

11. A dip molded article manufactured from the latex composition for dip molding according to claim 3.

12. The dip molded article according to claim 11,
wherein the dip molded article is surgical gloves, medical gloves, gloves for agricultural and livestock product processing, industrial gloves, condoms, cosmetic materials, catheters, or healthcare molded articles.

13. A dip molded article manufactured from the latex composition for dip molding according to claim 4.

14. The dip molded article according to claim 13,
wherein the dip molded article is surgical gloves, medical gloves, gloves for agricultural and livestock product processing, industrial gloves, condoms, cosmetic materials, catheters, or healthcare molded articles.

15. A dip molded article manufactured from the latex composition for dip molding according to claim 5.

16. The dip molded article according to claim 15,
wherein the dip molded article is surgical gloves, medical gloves, gloves for agricultural and livestock product processing, industrial gloves, condoms, cosmetic materials, catheters, or healthcare molded articles.

17. A dip molded article manufactured from the latex composition for dip molding according to claim 6.

18. The dip molded article according to claim 17,
wherein the dip molded article is surgical gloves, medical gloves, gloves for agricultural and livestock product processing, industrial gloves, condoms, cosmetic materials, catheters, or healthcare molded articles.
